(19) United States
(12) Patent Application Publication
(10) Pub. No.: US 2022/0092558 A1
(43) Pub. Date: Mar. 24, 2022

(54) MAINTENANCE ASSISTANCE DEVICE, MAINTENANCE ASSISTANCE METHOD, AND STORAGE MEDIUM

(71) Applicant: Mitsubishi Electric Corporation, Tokyo (JP)

(72) Inventors: Kenji MINE, Tokyo (JP); Chisato USHIDA, Tokyo (JP); Hirokazu KIKUTA, Tokyo (JP); Takayuki YAMAOKA, Tokyo (JP)

(73) Assignee: Mitsubishi Electric Corporation, Tokyo (JP)

(21) Appl. No.: 17/439,421

(22) PCT Filed: Apr. 23, 2019
(86) PCT No.: PCT/JP2019/017274

§ 371 Date: Sep. 15, 2021

(51) Int. Cl. G06Q 10/00; G06F 16/2457; G06F 16/248; G06T 17/05

(52) U.S. Cl. CPC G06Q 10/20; G06T 17/05; G06F 16/248; G06F 16/24575

(57) ABSTRACT

A maintenance assistance device includes a database in which maintenance assistance data is entered, an information obtaining unit to obtain, from a production facility, problem identification information indicating a problem having occurred in the production facility, an information retrieval unit to retrieve, from a plurality of pieces of maintenance assistance data entered in the database, maintenance assistance data corresponding to problem identification information obtained by the information obtaining unit, and a display control unit to display, on a display unit, a measure-taking method for a problem indicated by problem identification information obtained by the information obtaining unit, and a location of problem-causing factor, the location being the position of a target component on which the measure-taking method is implemented in the production facility, on the basis of maintenance assistance data retrieved by the information retrieval unit.

### FIELD

The present invention relates to a maintenance assistance device, a maintenance assistance method, and a maintenance assistance program to assist maintenance work on a production facility.

### BACKGROUND

At a production site such as a factory, when a problem occurs in a production facility, it is necessary to take proper measures to eliminate the problem as promptly as possible.

Normally, a maintenance staff is present at the production site, and when a problem is detected in the production facility, the maintenance staff checks the location where the problem has occurred and takes necessary measures based on the staff's knowledge, experience, and the like to resume a normal operation of the production facility. However, it is conceivable that a time required for resumption depends on whether the maintenance staff is skilled in the maintenance work. There can possibly be a significant difference in the time required for resumption between maintenance staffs depending on their skill levels, assuming that the same kind of problem has occurred. It is thus desirable that the length of time required since occurrence of a problem to resumption of a normal operation does not depend on the skill level of the maintenance staff. For example, it is conceivable to create a system to share useful information between the maintenance staffs, such as a measure-taking proposal for a predicted problem in a production facility and details of the actual measures that had been taken in the past at the occurrence of a problem, so that the length of time required for resumption is not significantly affected by the skill level of the maintenance staff.

It is described in Patent Literature 1 that a database is created in which details of the phenomenon of a problem occurring in a product are associated with information such as the cause of the problem and countermeasures against the problem, such that at the time of newly designing a product, a user can quickly retrieve and refer to various types of data related to the problems having occurred in the past in similar products (such as details of the phenomenon of the problem, the cause of the problem, and the countermeasures against the problem), and such that the various types of data related to the problems are displayed systematically so as to help the user find necessary data efficiently.

### CITATION LIST

### Patent Literature

Patent Literature 1: Japanese Patent Application Laid-open No. 2007-66263

### SUMMARY

### Technical Problem

In the invention described in Patent Literature 1, data related to the problems with a product is shared and used at a manufacturing site, so that the problems can be prevented from occurring. However, the invention described in Patent Literature 1 does not take into account maintenance work, and is thus the invention cannot be used for the purpose of improving the efficiency of maintenance work on a production facility. In general, various devices are combined to build a production facility. Further, a single device is formed of even smaller devices or components combined together. Under such circumstances, a problem may have occurred at a location different from the causal site of the problem. There is a case where a problem may have occurred at a location away from the causal site of the problem, and this may make it difficult to understand the correspondence relation between the location and the site. For example, when a decrease in the production volume of an article per time is detected from measurement values output by a sensor, the place to which the sensor is attached is the location where the problem has occurred. However, the causal site of the decrease in the production volume is different from the place to which the sensor is attached. There is another case where the decrease in the production volume is caused by a fault in a drive circuit of a motor that drives the belt of a belt conveyor. In this case, the attachment place of the sensor, where the problem has occurred, is located away from the location of the drive circuit where the actual fault has occurred. This makes it difficult to understand the correspondence relation between the place and the location. Meanwhile, the invention described in Patent Literature 1 does not take into account maintenance work, but is intended to prevent occurrence of problems at the manufacturing site. It is assumed that the location where the problem has occurred is near the causal site of the problem. It is also assumed that the location where the problem has occurred can be visually checked. Based on these assumptions, when the invention described in Patent Literature 1 is applied to a production facility, a maintenance staff may not be able to understand where to take measures in the production facility, and thus may possibly require additional time and effort to find out the proper location at which the measures are to be taken.

The present invention has been achieved to solve the above problems, and an object of the present invention is to provide a maintenance assistance device that improves the efficiency of maintenance work on a production facility.

### Solution to Problem

In order to solve the above problems and achieve the object, a maintenance assistance device according to the present invention comprises a database in which maintenance assistance data is entered, the maintenance assistance data including installation position information indicating the position of each of components in a production facility, the components forming the production facility, measure-taking method information indicating a measure-taking method for a predicted problem in the production facility, and problem identification information indicating a predicted problem in the production facility. The maintenance assistance device further comprises an information obtaining unit to obtain, from the production facility, problem identification information indicating a problem having occurred in the production facility, and an information retrieval unit to retrieve, from a plurality of pieces of maintenance assistance data entered in the database, maintenance assistance data corresponding to problem identification information obtained by the information obtaining unit. The maintenance assistance device further comprises a display control unit to display, on a display unit, a measure-taking method for a problem indicated by problem identification information obtained by the information obtaining unit, and a location of problem-causing factor, the location being the position of a target component on which the measure-taking method is implemented in the production facility, on the basis of maintenance assistance data retrieved by the information retrieval unit.

### Advantageous Effects of Invention

The maintenance assistance device according to the present invention has an effect where it is possible to improve the efficiency of maintenance work on a production facility.

### BRIEF DESCRIPTION OF DRAWINGS

FIG. 1 is a diagram illustrating a configuration example of a maintenance assistance system constituted by including a maintenance assistance device according to a first embodiment.

FIG. 2 is a diagram illustrating a configuration example of hardware to implement the maintenance assistance device.

FIG. 3 is a diagram illustrating an example of a production facility.

FIG. 4 is an explanatory diagram of an operation of a data creation device to obtain data related to a problem and then to enter the obtained data in a database.

FIG. 5 is a flowchart illustrating an example of the operation of the data creation device.

FIG. 6 is an explanatory diagram of an example of an operation of the maintenance assistance device according to the first embodiment.

FIG. 7 is a flowchart illustrating an example of the operation of the maintenance assistance device according to the first embodiment.

FIG. 8 is a diagram illustrating a configuration example of a maintenance assistance system constituted by including a maintenance assistance device according to a second embodiment.

FIG. 9 is a flowchart illustrating an example of an operation of a data obtaining unit included in the maintenance assistance device according to the second embodiment.

FIG. 10 is a flowchart illustrating an example of an operation of the maintenance assistance device according to the second embodiment.

### DESCRIPTION OF EMBODIMENTS

A maintenance assistance device, a maintenance assistance method, and a maintenance assistance program according to embodiments of the present invention will be described in detail below with reference to the drawings. The present invention is not limited to the embodiments.

### First Embodiment

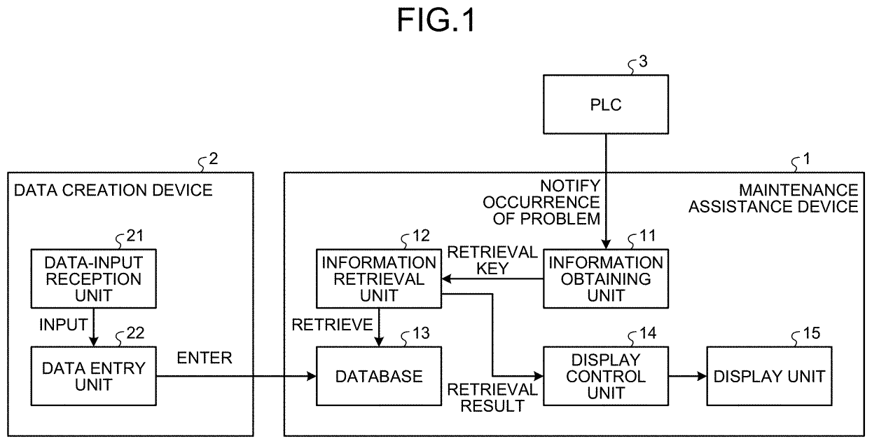

FIG. 1 is a diagram illustrating a configuration example of a maintenance assistance system constituted by including a maintenance assistance device according to a first embodiment. As illustrated in FIG. 1, the maintenance assistance system according to the first embodiment is constituted by including a maintenance assistance device 1 and a data creation device 2. The maintenance assistance device 1 connects to a PLC (Programmable Logic Controller) 3 that forms a production facility. The PLC 3 is a control device that controls a controlled device (not illustrated). The PLC 3 has a function of detecting a problem in the production facility on the basis of information obtained from the controlled device. It is allowable that the PLC 3 uses any method to detect a problem. For example, the PLC 3 checks measurement values output by various types of sensors attached on a manufacturing line of a production facility, and when the measurement values indicate irregular values, the PLC 3 determines that a problem has occurred. Upon detecting a problem, the PLC 3 notifies the maintenance assistance device 1 of the occurrence of a problem. The PLC 3 outputs identification information on the detected problem (hereinafter, referred to as “problem identification information”) to the maintenance assistance device 1 to notify the maintenance assistance device 1 of the occurrence of a problem.

The maintenance assistance device 1 includes an information obtaining unit 11, an information retrieval unit 12, a database 13, a display control unit 14, and a display unit 15.

The information obtaining unit 11 obtains problem identification information output from the PLC 3, and outputs the obtained problem identification information as a retrieval key to the information retrieval unit 12.

The information retrieval unit 12 uses the problem identification information received from the information obtaining unit 11 to retrieve data from the database 13. The information retrieval unit 12 outputs the result of the retrieval to the display control unit 14.

The database 13 receives and manages data created by the data creation device 2. The data created by the data creation device 2 is related to a predicted problem in a production facility. Examples of the above data include problem identification information, occurring phenomenon information indicating the appearing phenomenon, and measure-taking method information indicating a measure-taking method. The occurring phenomenon information indicates details of a problem. The database 13 holds therein design data on a production facility in advance. Upon reception of the data described above from the data creation device 2, the database 13 holds therein the received data in association with the design data on the production facility. Details of the design data on the production facility are described later. A method for associating the data received from the data creation device 2 with the design data on the production facility is explained later separately. In the following descriptions, data managed by the database 13 is referred to as “maintenance assistance data”.

The display control unit 14 displays the result of retrieval output from the information retrieval unit 12 on the display unit 15 to notify the result of retrieval to a user who is a maintenance worker of the production facility.

The data creation device 2 is, for example, a personal computer, and includes a data-input reception unit 21 and a data entry unit 22.

The data-input reception unit 21 receives input of data necessary for creating maintenance assistance data to be entered in the database 13 in the maintenance assistance device 1 from a worker who creates the database 13.

The data entry unit 22 creates maintenance assistance data on the basis of the input data received by the data-input reception unit 21, and enters the maintenance assistance data in the database 13 of the maintenance assistance device 1.

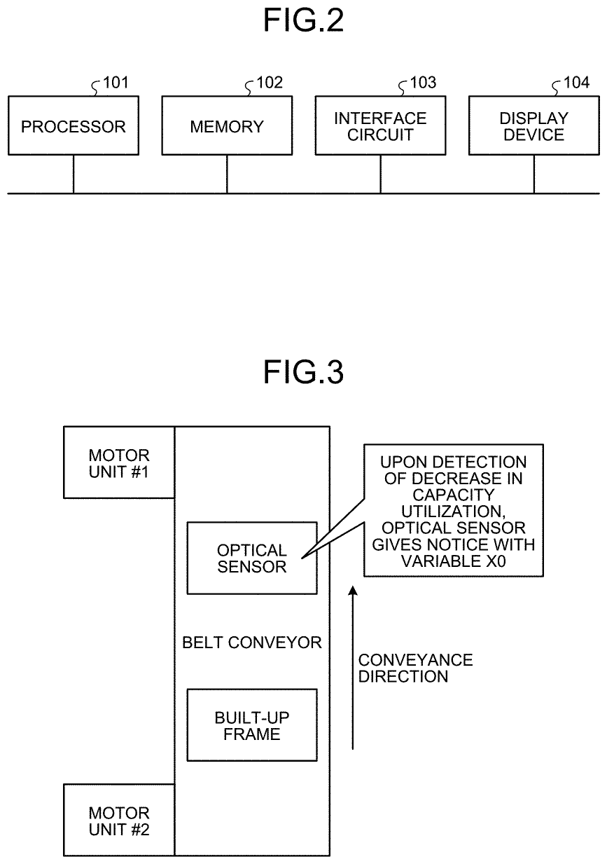

A hardware configuration to implement the maintenance assistance device 1 is now described. FIG. 2 is a diagram illustrating a configuration example of hardware to implement the maintenance assistance device 1.

The maintenance assistance device 1 is implemented by, for example, a processor 101, a memory 102, an interface circuit 103, and a display device 104 illustrated in FIG. 2.

The processor 101 corresponds to a CPU (also referred to as Central Processing Unit, central processor, processing device, computation device, microprocessor, microcomputer, processor, and DSP (Digital Signal Processor)), a system LSI (Large Scale Integration), or the like. The memory 102 corresponds to a nonvolatile or volatile semiconductor memory such as a RAM (Random Access Memory), a ROM (Read Only Memory), a flash memory, an EPROM (Erasable Programmable Read Only Memory), an EEPROM (registered trademark) (Electrically Erasable Programmable Read-Only Memory), or the like. The interface circuit 103 is a circuit for transmitting and receiving various types of data with other devices. The display device 104 corresponds to a liquid-crystal display monitor, a display, or the like. The hardware to implement the maintenance assistance device 1 may include an input device for receiving operations by a user in addition to the processor 101, the memory 102, the interface circuit 103, and the display device 104 described above. Examples of the input device are a keyboard, a mouse, a touch panel, and the like.

The information obtaining unit 11, the information retrieval unit 12, the database 13, and the display control unit 14 of the maintenance assistance device 1 are implemented by the processor 101 and the memory 102. Specifically, programs to operate as the information obtaining unit 11, the information retrieval unit 12, the database 13, and the display control unit 14 are stored in the memory 102. The processor 101 reads and executes the programs stored in the memory 102 to implement the above units of the maintenance assistance device 1.

The information obtaining unit 11 obtains problem identification information from the PLC 3 through the interface circuit 103. The maintenance assistance data to be entered in the database 13 by the data creation device 2 is transmitted from the data creation device 2 through the interface circuit 103 to the database 13. The display unit 15 is implemented by the display device 104.

It is allowable that the programs described above to implement the information obtaining unit 11, the information retrieval unit 12, the database 13, and the display control unit 14 of the maintenance assistance device 1 are stored in the memory 102 in advance to be provided to a user. It is also allowable that the programs described above are written into a computer-readable recording medium such as a CD (Compact Disc)-ROM or a DVD (Digital Versatile Disc)-ROM, and then the programs written into the recording medium are supplied to a user such that the user can install these programs onto the memory 102. The programs described above may also be provided to a user via a communication line such as the Internet.

Subsequently, descriptions are made on a configuration of maintenance assistance data to be entered in the database 13 included in the maintenance assistance device 1. The configuration of the maintenance assistance data is explained below along with a work procedure for entering the maintenance assistance data in the database 13 by using the data creation device 2. The work to be described below needs to be performed before the start of operation of the maintenance assistance device 1.

An example case is described, in which data related to a predicted problem in a production facility configured as illustrated in FIG. 3 is entered. FIG. 3 is a diagram illustrating an example of the production facility, and specifically illustrates an example of a conveyance facility. The conveyance facility illustrated in FIG. 3 includes a belt conveyor, motor units #1 and #2, and an optical sensor. The belt conveyor conveys a built-up frame as an intermediate of a product to be manufactured in the direction illustrated by an arrow. The optical sensor checks the capacity utilization by sensing the built-up frame conveyed by the belt conveyor. When the optical sensor detects a decrease in the capacity utilization, the optical sensor gives notice of the decrease with a variable X0. To be more exact, the optical sensor is connected to a control device equivalent to the PLC 3 illustrated in FIG. 1, and the control device calculates the capacity utilization and detects a decrease in the capacity utilization by analyzing signals output by the optical sensor. This control device notifies the maintenance assistance device 1 of the result of the detection with the variable X0. The variable X0 is problem identification information.

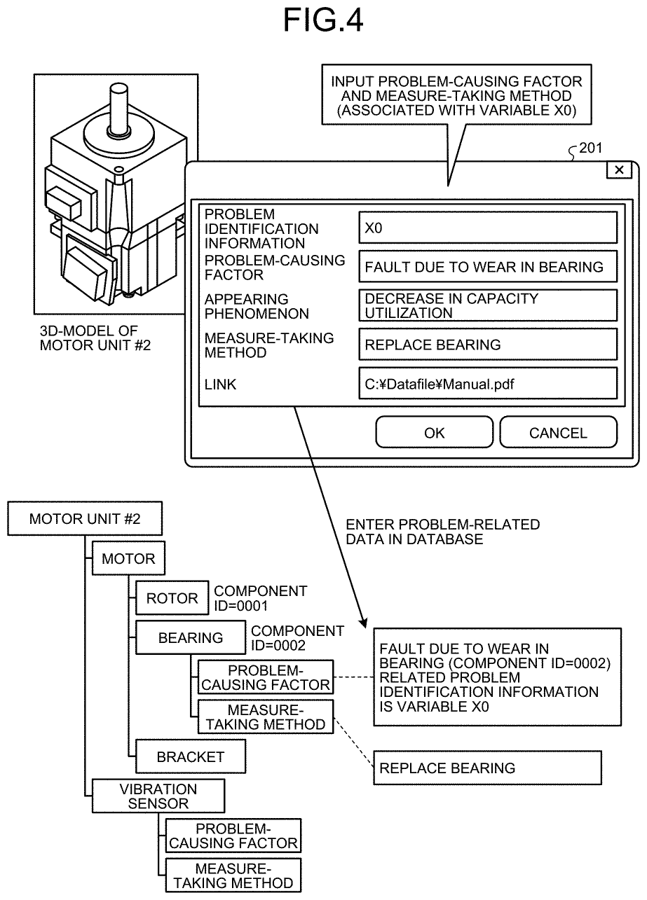

FIG. 4 is an explanatory diagram of an operation of the data creation device 2 to obtain data related to a predicted problem with the motor unit #2 of the production facility (conveyance facility) illustrated in FIG. 3, and then to enter the obtained data in the database 13. With reference to FIG. 4, the operation of the data creation device 2 to enter the data related to the problem with the motor unit #2 (hereinafter, “problem-related data”) is described.

As illustrated in FIG. 4, the motor unit #2 is formed of a plurality of components, specifically, a motor and a vibration sensor. The motor is further formed of even smaller components, specifically, a rotor, a bearing, and a bracket. As shown in the tree structure in FIG. 4, information indicating a relation between the components that constitute the motor unit #2 is included in design data on the production facility. This information is created at the time of designing the production facility. In addition to the information indicating the relation between the components, the design data on the production facility also includes information on specifications of each of the components, installation position information indicating the position of each of the components in the production facility, CAD (Computer-Aided Design) data showing the shape of the component, and another CAD data showing the configuration of the production facility in its entirety or a portion of the production facility.

The data creation device 2 obtains and holds therein the design data on the production facility in advance. In the following descriptions, a portion of the information included in the design data, which indicates the relation between the components, is referred to as “facility configuration information” for convenience of explanations. The data “problem-causing factor” and “measure-taking method” illustrated in FIG. 4 is not included in the design data on the production facility. The data “problem-causing factor” and “measure-taking method” is associated with the design data on the production facility upon reception of input of this data “problem-causing factor” and “measure-taking method” by the data-input reception unit 21. Maintenance assistance data is created by associating the data “problem-causing factor” and “measure-taking method” with the design data on the production facility. However, information to be associated with the design data on the production facility is not limited to the data “problem-causing factor” or “measure-taking method”. In addition to these types of information, another type of information may also be associated with the design data on the production facility to create maintenance assistance data.

In a case where the data-input reception unit 21 in the data creation device 2 receives input of data to be entered in the database 13, the data-input reception unit 21 displays, on the display unit (not illustrated), the components of the production facility in a tree form on the basis of the facility configuration information so that a user can understand the relation between the components. At this time, it is allowable for the data creation device 2 to additionally display a 3D-model of the component so that the user can understand the configuration of the component. A worker who creates the database 13 selects one of the minimal-configuration components displayed at the right end of the tree (the rotor, the bearing, the bracket, and the vibration sensor in the example in FIG. 4), and then operates the data creation device 2 to start inputting the problem-related data. For example, the worker clicks the right mouse button with the component being selected to invoke the menu, and starts inputting the problem-related data. Upon reception of this operation with the bearing being selected, the data creation device 2 displays a data input screen 201 on the display unit, and waits for input of the problem-related data on the bearing. Thereafter, the worker inputs each type of information, “problem identification information”, “problem-causing factor”, “appearing phenomenon”, “measure-taking method”, and “link” as the problem-related data. The information “problem-causing factor” refers to problem-causing factor information that indicates a factor that causes occurrence of a problem. The information “link” indicates, for example, the location where there is manual data on a component. The problem-related data does not necessarily include all the types of information described above. It is sufficient that the problem-related data includes at least the information “problem identification information” and “measure-taking method”. Even though a maintenance worker does not know the problem-causing factor or the appearing phenomenon, as long as the maintenance worker finds out a measure-taking method, then it is still possible to eliminate the problem by performing necessary work in accordance with the measure-taking method.

After the data-input reception unit 21 receives input of problem-related data and an “OK” button is pressed, the data-input reception unit 21 transmits the received input of problem-related data to the data entry unit 22. When the data entry unit 22 receives the problem-related data from the data-input reception unit 21, the data entry unit 22 associates the problem-related data with a component ID (IDentification) of the selected component as described above, specifically, the component ID of the bearing (component ID=0002) of the motor in the motor unit #2 included in the design data on the production facility. The data entry unit 22 then enters the associated data in the database 13. As a result, maintenance assistance data having a configuration in which component information (component ID) included in the design data on the production facility is associated with the problem-related data is entered in the database 13. The component ID having been entered in the database 13 in association with the problem-related data is measure-taking target component information indicating a component targeted for taking measures. In the example illustrated in FIG. 4, the problem-related data associated with the component ID is entered in the database 13. The problem-related data includes data indicating that the problem identification information is the variable X0, text data indicating that the problem-causing factor of the bearing with its component ID 0002 is wear in the bearing, and text data indicating that the measure-taking method for the problem is replacement of the bearing.

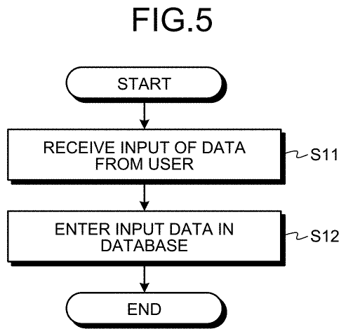

The operation of the data creation device 2 described above is illustrated in a flowchart in FIG. 5. FIG. 5 is a flowchart illustrating an example of the operation of the data creation device 2.

As illustrated in FIG. 5, the data creation device 2 receives input of data from a user (Step S11). That is, the data-input reception unit 21 receives input of problem-related data from a worker in such a manner as explained above with reference to FIG. 4.

Next, the data creation device 2 enters the input data in the database 13 (Step S12). That is, the data entry unit 22 receives problem-related data having been received by the data-input reception unit 21, generates maintenance assistance data in which the received problem-related data is associated with the component ID included in the design data on the production facility, and then enters the generated maintenance assistance data in the database 13.

The procedure for entering the maintenance assistance data in the database 13 has been explained above by using the bearing of the motor in the motor unit #2 illustrated in FIGS. 3 and 4 as an example. Maintenance assistance data on other components of the production facility is also entered in the database 13 in accordance with the same procedure as described above. By repeating the same procedure, a worker inputs problem-related data on the minimal-configuration components displayed at the right end of the tree. The data creation device 2 enters the input problem-related data in the database 13 in association with the component ID.

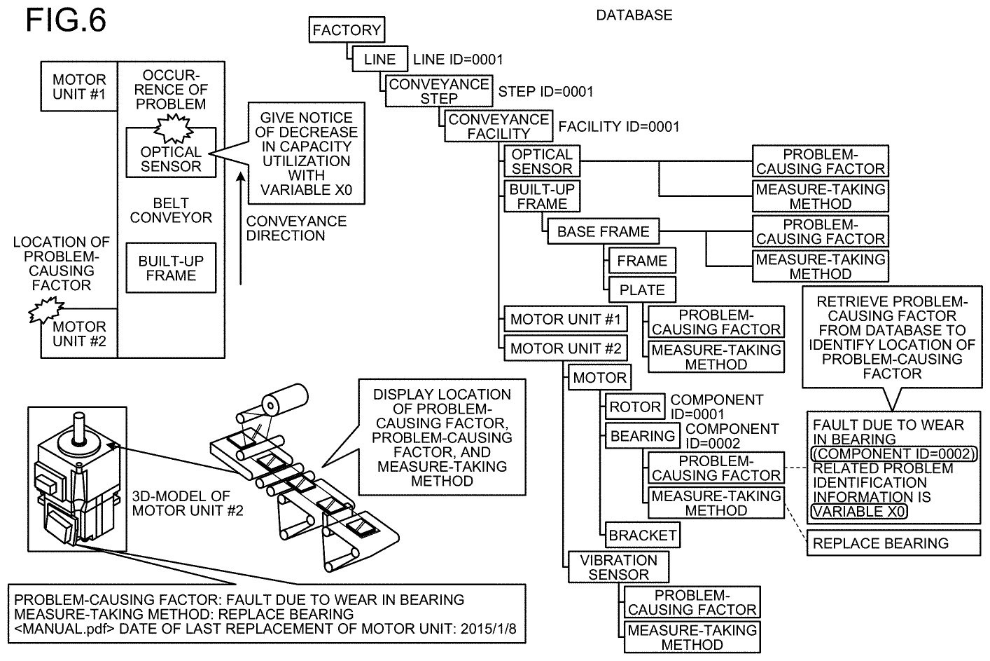

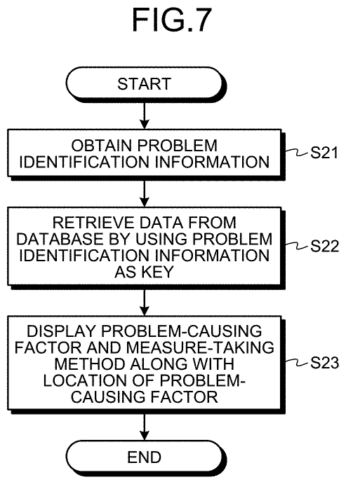

Subsequently, a specific example of the operation of the maintenance assistance device 1 is described with reference to FIGS. 6 and 7. FIG. 6 is an explanatory diagram of an example of the operation of the maintenance assistance device 1 according to the first embodiment. FIG. 7 is a flowchart illustrating an example of the operation of the maintenance assistance device 1 according to the first embodiment.

Descriptions are made on an example of an operation of the maintenance assistance device 1 when a problem has occurred, which is a decrease in the capacity utilization in a conveyance facility as illustrated at the left top of FIG. 6. This problem is detected by the PLC 3 monitoring the result of detection with an optical sensor. When the PLC 3 detects a decrease in the capacity utilization, the PLC 3 notifies the maintenance assistance device 1 of the occurrence of a problem by using the variable X0 that is the problem identification information.

As illustrated in FIG. 7, the maintenance assistance device 1 obtains the problem identification information output from the PLC 3 having detected the problem (Step S21). The information obtaining unit 11 performs this process at Step S21. In the example illustrated in FIG. 6, the information obtaining unit 11 obtains the variable X0 as the problem identification information.

Next, the maintenance assistance device 1 uses the problem identification information received from the PLC 3 as a key to retrieve data from the database 13 (Step S22). The information retrieval unit 12 performs this process at Step S22. In the example illustrated in FIG. 6, the information retrieval unit 12 uses the variable X0 as a key to retrieve data from the database 13, and identifies the bearing of the motor unit #2 assigned with the component ID (=0002) associated with the variable X0. The information retrieval unit 12 then obtains the problem-causing factor and the measure-taking method that are associated with the identified bearing, and also obtains the design data related to the conveyance facility (facility ID=0001) provided with the motor unit #2 including the bearing.

Next, on the basis of each type of data obtained by the retrieval from the database 13, the maintenance assistance device 1 displays the problem-causing factor and the measure-taking method on the display unit 15 along with the location of problem-causing factor (Step S23). The location of problem-causing factor refers to a location where a component is installed, the component having become a factor of the occurrence of the problem detected by the PLC 3. Thus, the location of problem-causing factor indicates the position of a target component on which the measure-taking method is implemented in the conveyance facility. The display control unit 14 performs this process at Step S23. In the example illustrated in FIG. 6, as shown at the left bottom of FIG. 6, the display control unit 14 displays, on the display unit 15, the 3D-model representing the overall configuration of the conveyance facility having the motor unit #2 installed therein, and the 3D-model of the motor unit #2 on the basis of the CAD data included in the design data and obtained by the information retrieval unit 12 at Step S22. The motor unit #2 includes the bearing with the problem having occurred. The display control unit 14 displays these 3D-models in such a display format that a user can understand the position of the motor unit #2 in the conveyance facility, and understand the position of the bearing in the 3D-model of the motor unit #2. Furthermore, the display control unit 14 displays the problem-causing factor and the measure-taking method on the display unit 15. In this example, 3D-models are used to inform a user of the position of the motor unit #2 in the conveyance facility, the motor unit #2 including the bearing with the problem having occurred, and the position of the bearing in the motor unit #2. However, the informing method is not limited thereto. It is allowable that the display control unit 14 uses any display method as long as a user can identify the whereabouts of the device (the motor unit #2 in the example in FIG. 6) installed in the production facility (the conveyance facility in the example in FIG. 6), and can identify which of the components (the bearing in the example in FIG. 6) of the device has a problem. For example, it is allowable to display the positional relation between the production facility, the device, and the component in a text format.

As described above, the maintenance assistance device 1 according to the present embodiment includes the database 13 to manage design data on a production facility, and data on a component-problem-causing factor and a measure-taking method which are associated with a component forming the production facility as maintenance assistance data. When a problem occurs in the production facility, on the basis of a portion of the maintenance assistance data managed by the database 13, which is associated with the problem having occurred, the maintenance assistance device 1 notifies a user of the position of a component that has become the factor of the occurrence of the problem and the measure-taking method. Accordingly, the maintenance assistance device 1 can improve the efficiency of maintenance work on the production facility.

In the present embodiment, the configuration example has been described in which the database 13 is present in the maintenance assistance device 1. However, it is allowable that the database 13 is provided outside the maintenance assistance device 1.

In the present embodiment, for the purpose of simplifying the descriptions, a single component associated with a single combination of the problem-causing factor and the measure-taking method is entered in the database 13. However, there may possibly be a plurality of types of predicted problems in a single component. It is thus allowable that a single component associated with a plurality of combinations of the problem-causing factor and the measure-taking method is entered in the database 13. In this case, when the maintenance assistance device 1 finds a plurality of pieces of data corresponding to the retrieval key at Step S22 described above, the maintenance assistance device 1 first displays, for example, a list of plural problem-causing factors at Step S23. Thereafter, when a user selects one of the problem-causing factors in the list, the maintenance assistance device 1 displays the location of problem-causing factor and the measure-taking method corresponding to the selected problem-causing factor.

### Second Embodiment

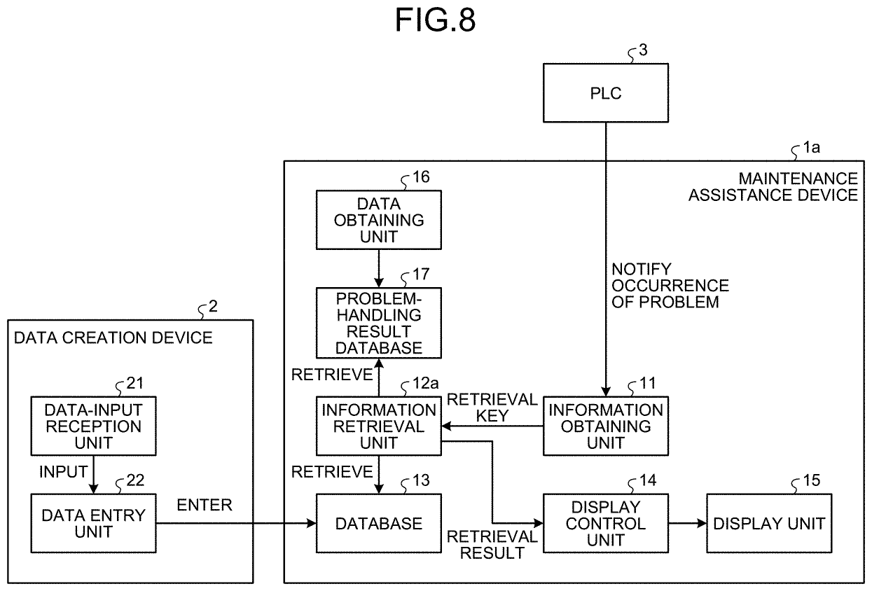

FIG. 8 is a diagram illustrating a configuration example of a maintenance assistance system constituted by including a maintenance assistance device according to a second embodiment. The maintenance assistance system according to the second embodiment is constituted by including a maintenance assistance device 1a, the data creation device 2, and the PLC 3. The data creation device 2 and the PLC 3 are identical to those in the first embodiment, therefore explanations thereof are omitted.

The maintenance assistance device 1a has a configuration in which the information retrieval unit 12 of the maintenance assistance device 1 according to the first embodiment is replaced with an information retrieval unit 12a, and a data obtaining unit 16 and a problem-handling result database 17 are added. In the present embodiment, different points from the maintenance assistance device 1 according to the first embodiment are mainly described.

As described above, the maintenance assistance device 1 according to the first embodiment enters a factor that causes a predicted problem, a measure-taking method, and other information in the database 13, and notifies a user of the measure-taking method entered in the database 13 at the occurrence of a problem. However, if an unpredicted problem occurs, a user needs to identify the factor that causes the problem by him/herself and take necessary measures to eliminate the problem. On the assumption that there is such a case, in the maintenance assistance device 1a according to the present embodiment, the data obtaining unit 16 obtains data indicating work details when a user has eliminated the problem by him/herself, and enters the obtained data in the problem-handling result database 17. Accordingly, when the same problem occurs again, a user can utilize the data in the problem-handling result database 17 and thus can efficiently eliminate the problem.

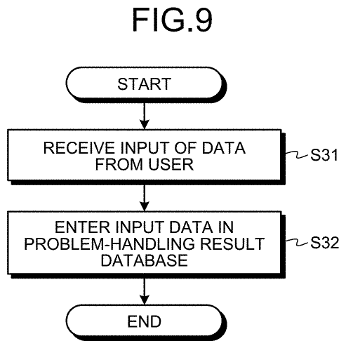

FIG. 9 is a flowchart illustrating an example of the operation of the data obtaining unit 16 included in the maintenance assistance device 1a according to the second embodiment. The data obtaining unit 16 receives input of data from a user who has worked on eliminating the problem, and obtains data related to the work performed to eliminate the problem (Step S31). The data obtaining unit 16 obtains the data indicating the work details at Step S31. In this example, the work details include a location where the problem has occurred, a factor that causes the problem, taken measures, and date and time at which the problem has occurred. The work details are described in the form of text data.

After having received input of data from a user, the data obtaining unit 16 enters the input data in the problem-handling result database 17 (Step S32). At this time, the data obtaining unit 16 enters the input data (data related to the work performed to eliminate the problem) in association with the problem identification information. The problem identification information associated with the input data is supposed to be the latest problem identification information notified from the PLC 3. The data related to the work performed to eliminate the problem, that is the data obtained by the data obtaining unit 16, is input only when the maintenance assistance device 1a cannot find a proper measure-taking method despite retrieval from the database 13 using the problem identification information notified from the PLC 3 as a key. That is, when there is no measure-taking method corresponding to the problem identification information notified from the PLC 3, a user works on eliminating the problem by him/herself, and thereafter the data related to the work performed is input. Thus, the data obtaining unit 16 enters the data obtained at Step S31 in the problem-handling result database 17 in association with the latest problem identification information notified from the PLC 3.

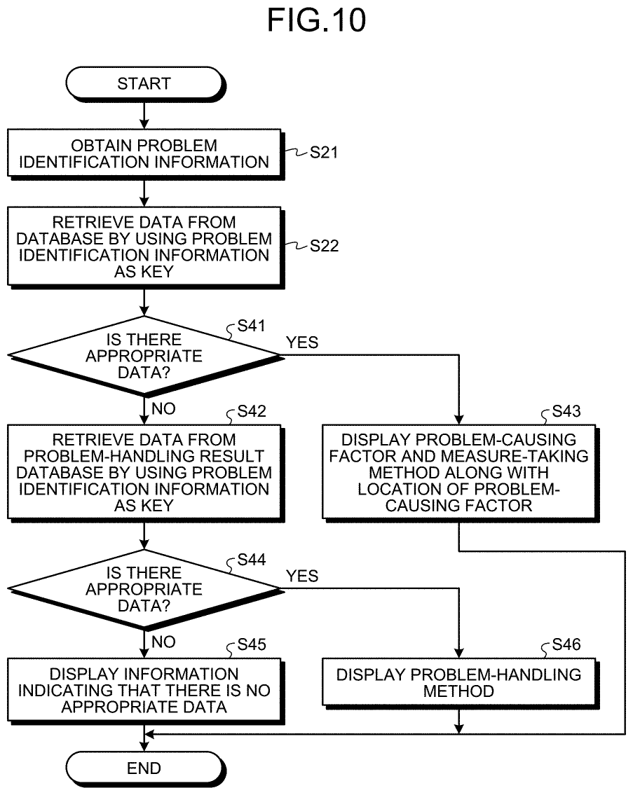

FIG. 10 is a flowchart illustrating an example of the operation of the maintenance assistance device 1a according to the second embodiment. Steps S21 and S22 in FIG. 10 are identical to Steps S21 and S22 in FIG. 7 in the first embodiment, and thus explanations thereof are omitted.

As illustrated in FIG. 10, after having performed the process at Step S22, the maintenance assistance device 1a checks whether there is corresponding data, that is, whether appropriate data has been found at Step S22 (Step S41). The information retrieval unit 12a performs this process at Step S41. When there is appropriate data (YES at Step S41), the maintenance assistance device 1a displays the problem-causing factor and the measure-taking method on the display unit 15 along with the location of problem-causing factor on the basis of each type of data obtained in the retrieval process at Step S22 (Step S43). This process at Step S43 is the same as the process at Step S23 in FIG. 7 described above in the first embodiment.

When there is no appropriate data (NO at Step S41), the maintenance assistance device 1a uses the problem identification information as a key to retrieve data from the problem-handling result database 17 (Step S42). The information retrieval unit 12a performs the retrieval at Step S42. The problem identification information serving as a retrieval key is the same as the problem identification information to be used for retrieval at Step S22.

Next, the maintenance assistance device 1a checks whether there is appropriate data, that is, whether appropriate data has been found at Step S42 (Step S44). The information retrieval unit 12a performs this process at Step S44. When there is appropriate data (YES at Step S44), the maintenance assistance device 1a displays the problem-handling method on the display unit 15 on the basis of the data obtained in the retrieval process at Step S42 (Step S46). The problem-handling method in this example refers to details of work to eliminate the problem indicated by the data entered in the problem-handling result database 17. The display control unit 14 performs this process at Step S46.

When there is no appropriate data (NO at Step S44), the maintenance assistance device 1a displays information indicating that there is no appropriate data on the display unit 15 (Step S45). The display control unit 14 performs this process at Step S45.

In the present embodiment, the data obtaining unit 16 and the problem-handling result database 17 are provided inside the maintenance assistance device 1a. However, one or both of the elements may be provided outside the maintenance assistance device 1a. For example, the maintenance assistance device 1a may have a configuration in which the problem-handling result database 17 is provided in a server device connected to the maintenance assistance device 1a through a communication network. The data obtaining unit 16 may be a personal computer, a tablet terminal, a smart phone, or other devices that are connectable to the communication network, and that have installed therein a dedicated application to enter data in the problem-handling result database 17.

As described above, the maintenance assistance device 1a according to the present embodiment has a configuration in which the data obtaining unit 16 and the problem-handling result database 17 are added to the maintenance assistance device 1 according to the first embodiment. The data obtaining unit 16 obtains data related to work from a user who has worked on eliminating a problem in a production facility. The problem-handling result database 17 manages the data obtained by the data obtaining unit 16. The maintenance assistance device 1a allows a user to utilize data on work previously performed to eliminate the problem. This makes it possible for the user to perform maintenance work more efficiently as compared to the first embodiment.

The configurations described in the above embodiments are only examples of the content of the present invention. The configurations can be combined with other well-known techniques, and part of each of the configurations can be omitted or modified without departing from the scope of the present invention.

### REFERENCE SIGNS LIST

1, 1a maintenance assistance device; 2 data creation device; 3 PLC; 11 information obtaining unit; 12, 12a information retrieval unit; 13 database; 14 display control unit; 15 display unit; 16 data obtaining unit; 17 problem-handling result database; 21 data-input reception unit; 22 data entry unit; 201 data input screen.

1. A maintenance assistance device comprising:
a database in which maintenance assistance data is entered, the maintenance assistance data including installation position information indicating a position of each of components in a production facility, the components forming the production facility, measure-taking method information indicating a measure-taking method for a predicted problem in the production facility, problem identification information indicating a predicted problem in the production facility, and problem-causing factor information indicating a factor that causes occurrence of a predicted problem in the production facility;
information obtaining circuitry to obtain, from the production facility, problem identification information indicating a problem having occurred in the production facility;
information retrieval circuitry to retrieve, from a plurality of pieces of maintenance assistance data entered in the database, maintenance assistance data corresponding to problem identification information obtained by the information obtaining circuitry; and
display control circuitry to display, on a display, a measure-taking method for a problem indicated by problem identification information obtained by the information obtaining circuitry, a location of problem-causing factor, the location being a position of a target component on which the measure-taking method is implemented in the production facility, and a factor that causes occurrence of a problem, on a basis of maintenance assistance data retrieved by the information retrieval circuitry, wherein
in the maintenance assistance data, a component ID is associated with the problem identification information, and
on a basis of the problem identification information obtained by the information obtaining circuitry, the information retrieval circuitry identifies a component assigned a component ID associated with the problem identification information, and identifies the measure-taking method for a problem related to an identified component, the factor that causes occurrence of a problem, and the production facility.

2. The maintenance assistance device according to claim 1, wherein the display control circuitry displays a position of a target component on which the measure-taking method is implemented in the production facility on the display in such a form as to display the position on a 3D-model of the production facility.

3. The maintenance assistance device according to claim 1, wherein
the maintenance assistance data further includes problem-causing factor information indicating a factor that causes occurrence of a predicted problem in the production facility, and
the display control circuitry displays, on the display, a factor that causes occurrence of a problem indicated by problem identification information obtained by the information obtaining circuitry.

4. The maintenance assistance device according to claim 1, comprising:
data obtaining circuitry to receive input of data indicating details of work having been performed to eliminate a problem having occurred in the production facility; and
a problem-handling result database in which data obtained by the data obtaining circuitry and problem identification information are entered while being associated with each other, the problem identification information indicating a problem having been eliminated by performing the work, wherein
when there is no maintenance assistance data corresponding to problem identification information obtained by the information obtaining circuitry among pieces of maintenance assistance data entered in a database, the information retrieval circuitry retrieves data corresponding to problem identification information obtained by the information obtaining circuitry from data entered in the problem-handling result database, and
the display control circuitry displays, on the display, details of work indicated by data found in the problem-handling result database by the information retrieval circuitry.

5. A maintenance assistance method to be executed by a maintenance assistance device including a database in which maintenance assistance data is entered, the maintenance assistance data including installation position information indicating a position of each of components in a production facility, the components forming the production facility, measure-taking method information indicating a measure-taking method for a predicted problem in the production facility, problem identification information indicating a predicted problem in the production facility, and problem-causing factor information indicating a factor that causes occurrence of a predicted problem in the production facility, the maintenance assistance method comprising:
obtaining, from the production facility, problem identification information indicating a problem having occurred in the production facility;
retrieving, from a plurality of pieces of maintenance assistance data entered in the database, maintenance assistance data corresponding to problem identification information obtained; and
displaying a measure-taking method for a problem indicated by problem identification information obtained, a location of problem-causing factor, the location being a position of a target component on which the measure-taking method is implemented in the production facility, and a factor that causes occurrence of a problem, on a basis of maintenance assistance data retrieved, wherein
in the maintenance assistance data, a component ID is associated with the problem identification information, and
retrieving the maintenance assistance data includes identifying a component assigned a component ID associated with the problem identification information, and identifying the measure-taking method for a problem related to an identified component, the factor that causes occurrence of a problem, and the production facility, on a basis of the problem identification information obtained.

6. A non-transitory storage medium storing a maintenance assistance program that causes a computer to execute processing in a maintenance assistance device including a database in which maintenance assistance data is entered, the maintenance assistance data including installation position information indicating a position of each of components in a production facility, the components forming the production facility, measure-taking method information indicating a measure-taking method for a predicted problem in the production facility, problem identification information indicating a predicted problem in the production facility, and problem-causing factor information indicating a factor that causes occurrence of a predicted problem in the production facility, the maintenance assistance program causing the computer to execute:
obtaining, from the production facility, problem identification information indicating a problem having occurred in the production facility;
retrieving, from a plurality of pieces of maintenance assistance data entered in the database, maintenance assistance data corresponding to problem identification information obtained; and
displaying a measure-taking method for a problem indicated by problem identification information obtained, a location of problem-causing factor, the location being a position of a target component on which the measure-taking method is implemented in the production facility, and a factor that causes occurrence of a problem, on a basis of maintenance assistance data retrieved, wherein
in the maintenance assistance data, a component ID is associated with the problem identification information, and
retrieving the maintenance assistance data includes identifying a component assigned a component ID associated with the problem identification information, and identifying the measure-taking method for a problem related to an identified component, the factor that causes occurrence of a problem, and the production facility, on a basis of the problem identification information obtained.

7. The maintenance assistance device according to claim 2, wherein
the maintenance assistance data further includes problem-causing factor information indicating a factor that causes occurrence of a predicted problem in the production facility, and
the display control circuitry displays, on the display, a factor that causes occurrence of a problem indicated by problem identification information obtained by the information obtaining circuitry.

8. The maintenance assistance device according to claim 2, comprising:
data obtaining circuitry to receive input of data indicating details of work having been performed to eliminate a problem having occurred in the production facility; and
a problem-handling result database in which data obtained by the data obtaining circuitry and problem identification information are entered while being associated with each other, the problem identification information indicating a problem having been eliminated by performing the work, wherein
when there is no maintenance assistance data corresponding to problem identification information obtained by the information obtaining circuitry among pieces of maintenance assistance data entered in a database, the information retrieval circuitry retrieves data corresponding to problem identification information obtained by the information obtaining circuitry from data entered in the problem-handling result database, and
the display control circuitry displays, on the display, details of work indicated by data found in the problem-handling result database by the information retrieval circuitry.

9. The maintenance assistance device according to claim 3, comprising:
data obtaining circuitry to receive input of data indicating details of work having been performed to eliminate a problem having occurred in the production facility; and
a problem-handling result database in which data obtained by the data obtaining circuitry and problem identification information are entered while being associated with each other, the problem identification information indicating a problem having been eliminated by performing the work, wherein
when there is no maintenance assistance data corresponding to problem identification information obtained by the information obtaining circuitry among pieces of maintenance assistance data entered in a database, the information retrieval circuitry retrieves data corresponding to problem identification information obtained by the information obtaining circuitry from data entered in the problem-handling result database, and
the display control circuitry displays, on the display, details of work indicated by data found in the problem-handling result database by the information retrieval circuitry.

10. The maintenance assistance device according to claim 7, comprising:
data obtaining circuitry to receive input of data indicating details of work having been performed to eliminate a problem having occurred in the production facility; and
a problem-handling result database in which data obtained by the data obtaining circuitry and problem identification information are entered while being associated with each other, the problem identification information indicating a problem having been eliminated by performing the work, wherein
when there is no maintenance assistance data corresponding to problem identification information obtained by the information obtaining circuitry among pieces of maintenance assistance data entered in a database, the information retrieval circuitry retrieves data corresponding to problem identification information obtained by the information obtaining circuitry from data entered in the problem-handling result database, and
the display control circuitry displays, on the display, details of work indicated by data found in the problem-handling result database by the information retrieval circuitry.
